(19) United States
(12) Patent Application Publication
(10) Pub. No.: US 2007/0253043 A1
(43) Pub. Date: Nov. 1, 2007

(54) Apparatus and method for holographic information storage and retrieval

(76) Inventors: Allen Keith Bates, Tucson, AZ (US); Nils Haustein, Soergenloch (DE); Craig Anthony Klein, Tucson, AZ (US); Henry Zheng Liu, Tucson, AZ (US); Daniel James Winarski, Tucson, AZ (US)

Correspondence Address: DALE F. REGELMAN, 4231 S. FREMONT AVENUE, TUCSON, AZ, 85714, US

(21) Appl. No.: 11/412,658

(22) Filed: Apr. 26, 2006

(51) Int. Cl. G03H 1/04

(52) U.S. Cl. 359/35; 359/21

(57) ABSTRACT

A holographic information recording apparatus is disclosed. The holographic information recording apparatus comprises a laser light source, a beam splitter, and a reflective spatial light modulator. The beam splitter provides a reference beam and a carrier beam, where that reference beam is directed without reflection toward a holographic data storage medium. The carrier beam is reflected off the reflective spatial light modulator to form a data beam comprising an image of information. The reference beam interacts with the data beam to form a hologram comprising the image. That hologram is then encoded in a holographic data storage medium.

### FIELD OF THE INVENTION

This invention relates to an apparatus, and method using that apparatus, to store and retrieval information encoded in a holographic data storage medium.

### BACKGROUND OF THE INVENTION

In holographic information storage, an entire page of information is stored at once as an optical interference pattern within a thick, photosensitive optical material. This is done by intersecting two coherent laser beams within the storage material. The first, called the data beam, contains the information to be stored; the second, called the reference beam, is designed to be simple to reproduce—for example, a simple collimated beam with a planar wavefront.

The resulting optical interference pattern, of the two coherent laser beams, causes chemical and/or physical changes in the photosensitive medium: a replica of the interference pattern is stored as a change in the absorption, refractive index, or thickness of the photosensitive medium. When the stored interference grating is illuminated with one of the two waves that was used during recording, some of this incident light is diffracted by the stored grating in such a fashion that the other wave is reconstructed. Illuminating the stored grating with the reference wave reconstructs the data beam, and vice versa.

A large number of these interference gratings or patterns can be superimposed in the same thick piece of media and can be accessed independently, as long as they are distinguishable by the direction or the spacing of the gratings. Such separation can be accomplished by changing the angle between the object and reference wave or by changing the laser wavelength. Any particular data page can then be read out independently by illuminating the stored gratings with the reference wave that was used to store that page. Because of the thickness of the hologram, this reference wave is diffracted by the interference patterns in such a fashion that only the desired object beam is significantly reconstructed and imaged on an electronic camera. The theoretical limits for the storage density of this technique are on the order of tens of terabits per cubic centimeter.

What is needed is an apparatus, and a method using that apparatus, to enhance the speed and reliability of holographic information storage.

### SUMMARY OF THE INVENTION

Applicants' invention comprises a holographic information recording apparatus. The holographic information recording apparatus comprises a laser light source, a beam splitter, and a reflective spatial light modulator. The beam splitter provides a reference beam and a carrier beam, where that reference beam is directed without reflection toward a holographic data storage medium. The carrier beam is reflected off the reflective spatial light modulator to form a data beam comprising an image of information. The reference beam interacts with the data beam to form a hologram comprising the image. That hologram is then encoded in a holographic data storage medium.

Applicants' invention further comprises a holographic information reading apparatus. The holographic information reading apparatus comprises a laser light source, a beam splitter, and an optical sensor. The laser light source provides a laser beam to the beam splitter, where that beam splitter provides a reference beam which is directed without reflection toward a holographic data storage medium comprising an encoded hologram comprising information. The optical sensor detects an image resulting from the interaction of the reference beam with the encoded hologram.

Applicants' invention further comprises a data storage system which comprises Applicants' holographic information recording apparatus and Applicants' holographic information reading apparatus. Applicants' invention further comprises a method to write information to, and/or read information from, a holographic data storage medium.

### BRIEF DESCRIPTION OF THE DRAWINGS

The invention will be better understood from a reading of the following detailed description taken in conjunction with the drawings in which like reference designators are used to designate like elements, and in which:

FIG. 1 is a view of a prior art holographic information recording apparatus;

FIG. 2 is a block diagram showing Applicants' holographic information recording apparatus;

FIG. 3 is a perspective view of Applicants' holographic information recording apparatus;

FIG. 4 is a perspective view of a prior art holographic information reading apparatus; and

FIG. 5 is a perspective view of Applicants' holographic information reading apparatus;

FIG. 6 is a block diagram of Applicants' data storage system which comprises Applicants' holographic information recording apparatus of FIGS. 2 and 3, and Applicants' holographic information reading apparatus of FIG. 5;

FIG. 7 is a flow chart summarizing the steps of Applicants' method to record information in a holographic data storage medium using the holographic information recording apparatus of FIGS. 2 and 3; and

FIG. 8 is a flow chart summarizing the steps of Applicants' method to read information from a holographic data storage medium using the holographic information reading apparatus of FIG. 5.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment, ” “an embodiment,” or similar language means that a particular feature, structure, or characteristic described in connection with the embodiment is included in at least one embodiment of the present invention. Thus, appearances of the phrases “in one embodiment, ” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

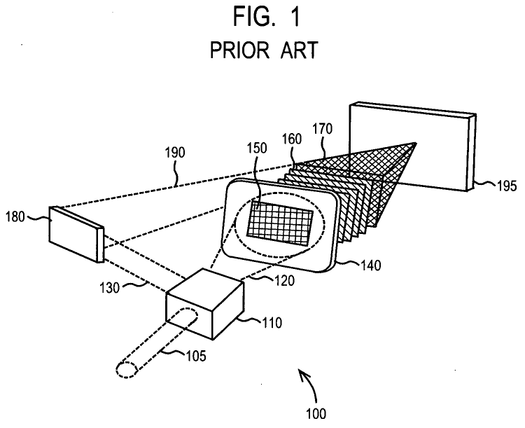

FIG. 1 illustrates a prior art holographic information recording apparatus 100. Apparatus 100 comprises a laser light source 105, a laser splitter 110, data carrier beam 120, and reference beam 130. In the illustrated embodiment of FIG. 1, apparatus 100 further comprises a Spatial Light Modulator (“SLM”) 140, a data beam 160, a mirror 180, and a holographic data storage medium 195.

Generally, the SLM 140 is an LCD-type device. Information is represented by either a light or a dark pixel on the SLM 140 display. The SLM 140 is typically translucent. Laser light originating from the laser source 105 is split by the beam splitter 110 into two beams, a carrier beam 120 and a reference beam 130.

The carrier beam 120 picks up the image 150 displayed by the SLM 140 as the light passes through the SLM 140. As carrier beam 120 passes through SLM 140 its intensity is necessarily diminished. The result is a data beam 160 comprising image 150 and a prior art transmissive data beam intensity.

Reference beam 130 is reflected by the mirror 180 to produce reflected reference beam 190 comprising a reflected reference beam intensity. Reflected reference beam 190 interferes with the data beam 160 to form hologram 170 comprising a prior art hologram intensity. The resulting 170 is stored on a holographic storage medium 195. Mirror 180 is typically a first-surface mirror.

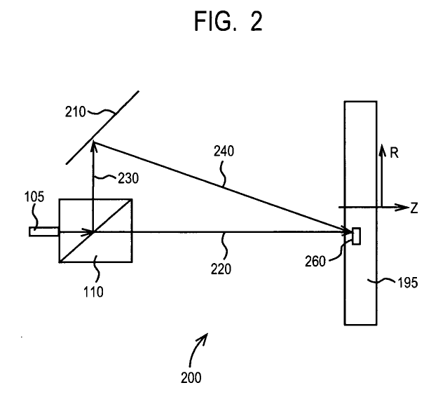

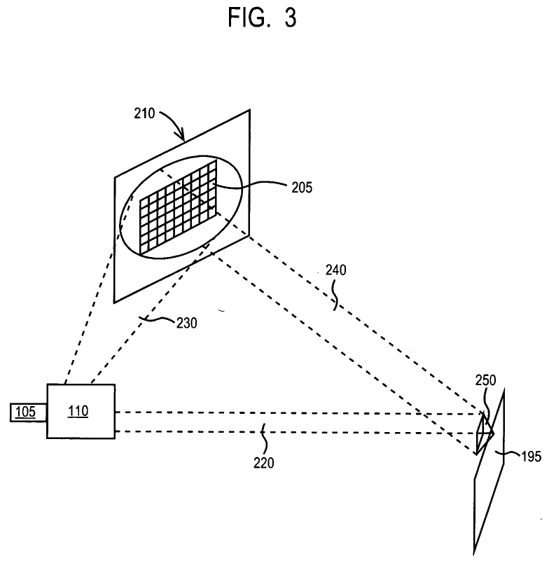

Referring now to FIGS. 2 and 3, Applicants' holographic information recording apparatus 200 comprises laser light source 105, splitter 110, reflective spatial light modulator 210, and holographic storage medium 195. The light generated by source 105 is split by splitter 110 into reference beam 220, and data carrier beam 230. Using Applicants' apparatus 200, reference beam 220 is not reflected, and therefore, comprises an unreflected reference beam intensity, wherein that unreflected reference beam intensity is greater than the reflected reference beam intensity generated by the prior apparatus 100.

Reflective spatial light modulator 210 comprises data image 205. In certain embodiments, reflective spatial light modulator 210 comprises an assembly comprising a plurality of micro mirrors. In other embodiments, reflective spatial light modulator 210 comprises a liquid crystal on silicon (“LCOS”) display device. In contrast to nematic twisted liquid crystals used in LCDs, in which the crystals and electrodes are sandwiched between polarized glass plates, LCOS devices have the liquid crystals coated over the surface of a silicon chip. The electronic circuits that drive the formation of the image are etched into the chip, which is coated with a reflective (aluminized) surface. The polarizers are located in the light path both before and after the light bounces off the chip. LCOS devices are easier to manufacture than conventional LCD displays. LCOS devices have higher resolution because several million pixels can be etched onto one chip. LCOS devices can be much smaller than conventional LCD displays.

Carrier beam 230 picks up image 205 as the light is reflected off reflective spatial light modulator 210 to form reflected data beam 240 comprising image 205 and a reflected data beam intensity, wherein the reflected data beam intensity is greater than the prior art transmissive data beam intensity because light reflected from reflective SLM 210 is typically of a higher intensity than light transmitted through a LCD-type transmissive SLM.

Unreflected reference beam 220 interferes with reflected data beam 240 to form hologram 250 comprising a first intensity, wherein that first is greater than the prior art hologram intensity. In essence, Applicants' holographic information recording apparatus 200 produces a data signal comprising a higher signal strength than the data signal produced using the prior art apparatus 100. Hologram 250 is formed within storage medium 195 thereby causing the photo-active storage medium to create interference pattern 260 comprising an encoded hologram 250.

Applicants' holographic information recording apparatus 200 eliminates the prior art mirror 180 (FIG. 1) used to reflect reference beam 130 (FIG. 1). Eliminating mirror 180 reduces the complexity of the holographic information recording apparatus, and also, eliminates a loss mechanism from the holographic recording process. In addition, Applicants' holographic information recording apparatus 200 eliminates the prior art transmissive spatial light modulator 140 (FIG. 1), and instead utilizes a reflective spatial light modulator 210 (FIGS. 2, 3), thereby eliminating from the holographic recording process a second loss mechanism, i.e. transmitting the carrier beam through spatial light modulator 140.

In certain embodiments, storage medium 195 comprises a photo polymer system. For example in certain embodiments, the recording of holograms occurs through a spatial pattern of polymerization of the photosensitive species that mimics the optical interference pattern produced by reference beam 220 and data beam 240. Thus, the incoming holographic image causes one or more chemical or physical changes in the recording medium to take place, such as photo-induced polymerization, photo-induced crosslinking, and the like.

The first law of photochemistry, known as the Grotthuss-Draper law, posits that light must be absorbed by a chemical substance in order for a photochemical reaction to take place. The second law of photochemistry, the Stark-Einstein law, posits that for each photon of light absorbed by a chemical system, only one molecule is activated for a photochemical reaction.

Increasing the intensity of a light beam does not change the energy of the constituent photons, only the number of molecules being activated. By increasing the intensity of the hologram 250 produced using Applicants' holographic information recording apparatus 200, compared to prior art hologram 170 produced using prior art apparatus 100, a greater number of storage medium photo-sensitive molecules are activated per unit of time, thereby increasing the rate of the information storage process, i.e. increasing the speed of holographic information recording. This is true if laser source 105 comprises a “red” laser, such as for example a ZnSe laser, GaN laser, or second-harmonic generation (SHG) laser. Emitting laser light have wavelengths of between about 630 to 650 nm, or a “blue” or “violet” laser, such as for example a ZnSe laser or a GaN In-doped laser, emitting laser light having wavelengths as low as 400 nm.

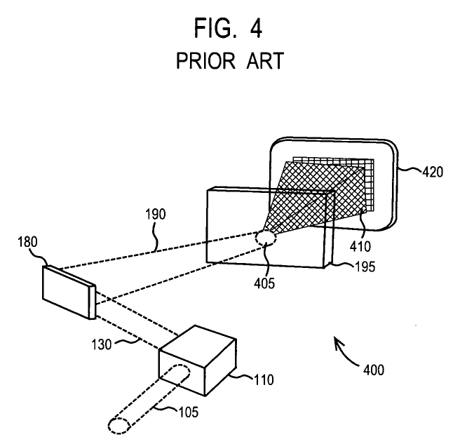

FIG. 4 illustrates a prior art holographic information reading apparatus 400. Apparatus 400 comprises laser light source 105, beam splitter 110, holographic storage medium 195, and optical sensor 420. Optical sensor 420 is disposed a distance away from the holographic storage medium 195 sufficient to accurately capture the image 410 projected. To read the hologram, reference beam 130 is reflected off of mirror 180, to become reflected reference beam 190, which is then incident on the holographic storage medium 195. As the reference beam 190 interferes with the encoded hologram 405 stored on the storage medium 195, an image 410 resembling the original image 150 (FIG. 1) displayed by the SLM 140 (FIG. 1) is projected against the optical sensor 420. The optical sensor 420 then captures the information comprising image 410.

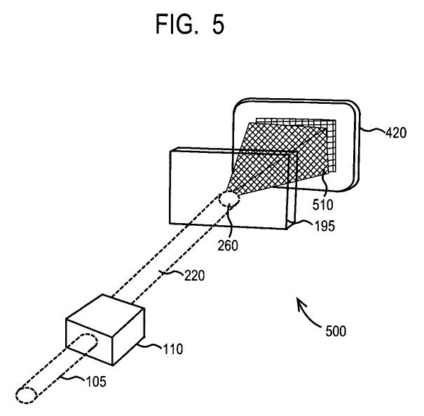

FIG. 5 shows Applicants' holographic information reading apparatus 500. Apparatus 500 comprises laser light source 105, optional beam splitter 110, and optical sensor 420. Light source 105 and splitter 110 provide reference beam 220.

The unreflected reference beam 220 is directed to holographic storage medium 195 such that reference beam 220 is diffracted by the interference pattern 260 (FIG. 2) to form image 510 resembling the original image 205 (FIG. 3) displayed on Applicants' reflective spatial light modulator 210. Image 510 is projected against the optical sensor 420. The optical sensor 420 then captures the information comprising image 510.

In the illustrated embodiment of FIG. 5, Applicants' holographic information reading apparatus 500 comprises beam splitter 110. In other embodiments, Applicants' holographic information reading apparatus 500 does not comprise a beam splitter. In these embodiments, laser light source 105 provides reference beam 220, which is directed without reflection to holographic storage medium 195 such that reference beam 220 is diffracted by the interference pattern 260 (FIG. 2) to form image 510 resembling the original image 205 (FIG. 3) displayed on Applicants' reflective spatial light modulator 210. Image 510 is projected against the optical sensor 420. The optical sensor 420 then captures the information comprising image 510.

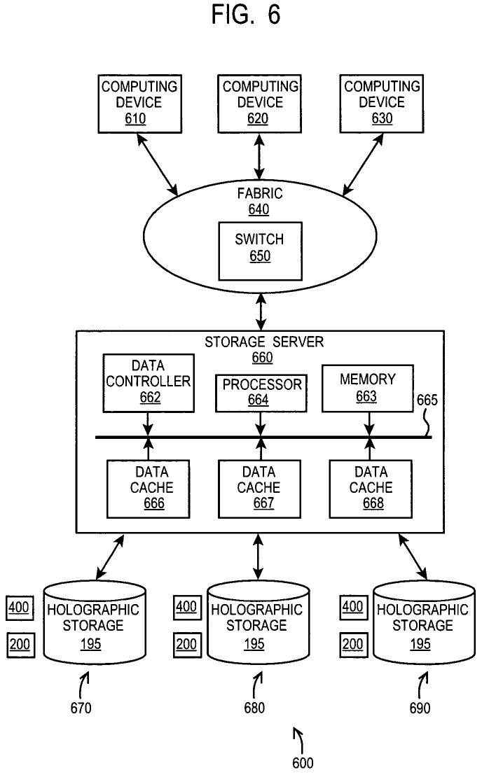

FIG. 6 illustrates one embodiment of Applicants' information storage system 600. In certain embodiments, system 600 comprises a Storage Area Network (“SAN”). In certain embodiments, the system 600 comprises one or more computing devices, such as computing devices 610, 620, and 630. In the illustrated embodiment of FIG. 6, the one or more computing devices communicate with a storage server 660 through a data communication fabric 640. The fabric 640 comprises may one or more data switches 650. Further in the illustrated embodiment of FIG. 6, storage server 660 communicates with one or more of Applicants' holographic data storage systems. In the illustrated embodiment of FIG. 6, storage system 600 comprises holographic storage systems 670, 680, and 690, wherein each of those holographic storage systems comprises Applicants' holographic information recording apparatus 200, Applicants' holographic information reading apparatus 400, and one or more holographic storage media 195.

In certain embodiments, computing devices 610, 620, and 630, are selected from the group consisting of an application server, a web server, a work station, a host computer, or other like device from which information is likely to originate. In certain embodiments, one or more of computing devices 610, 620, and/or 630 are interconnected with fabric 640 using Small Computer Systems Interface (“SCSI”) protocol running over a Fibre Channel (“FC”) physical layer. In other embodiments, the interconnects between computing devices 610, 620, and 630, comprise other protocols, such as Infiniband, Ethernet, or Internet SCSI (“iSCSI”). In certain embodiments, switches 650 are configured to route traffic from the computing devices 610, 620, and/or 630, directly to the storage server 660.

In the illustrated embodiment of FIG. 6, storage server 660 comprises a data controller 662, memory 663, processor 664, and data caches 666, 667, and 668, wherein these components communicate through a data bus 665. In certain embodiments, memory 663 comprises a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like

In certain embodiments, the data controller 662 is configured to read data signals from and write data signals to a serial data bus on one or more of the computing devices 610, 620, and/or 630. Alternatively, in other embodiments the data controller is configured to read data signals from and write data signals to one or more of the computing devices 610, 620, and/or 630, through the data bus 665 and the fabric 640.

In certain embodiments, data controller 662 converts a serial data stream into a convolution encoded data image, such as data image 205 (FIG. 3). Data image 205 is transferred to the spatial light modulator 210 (FIG. 3) pertaining to the holographic storage 670, 680 and 690. In certain embodiments, data controller 662 reads data from and writes information to one or more of the holographic storage media 195, using Applicants' holographic information recording apparatus 200 and/or Applicants' holographic information reading apparatus 400. In certain embodiments, data controller 662 writes data to one or more data caches 666, 667, and/or 668, for assembly of an optical image. The data images 205 are then written to the holographic storage media 195 using Applicants' holographic information recording apparatus 200.

In certain embodiments, holographic storage media 195 may be disposed in different information storage facilities located in different geographical places so that the loss of any one information storage facility only results in the loss of one of these storage media, which aids in the disaster recovery of the stored information. In certain embodiments, data controller 662 distributes information between two or more holographic storage media 195 in order to protect the information. In certain embodiments, data controller 662 encodes three bits of data into three 2×2 matrices, and the three matrices are distributed across three separate holographic storage media 195, in order that information lost on one of the storage media 195 may be recovered from the encoded interference patterns written to the remaining two holographic storage media 195.

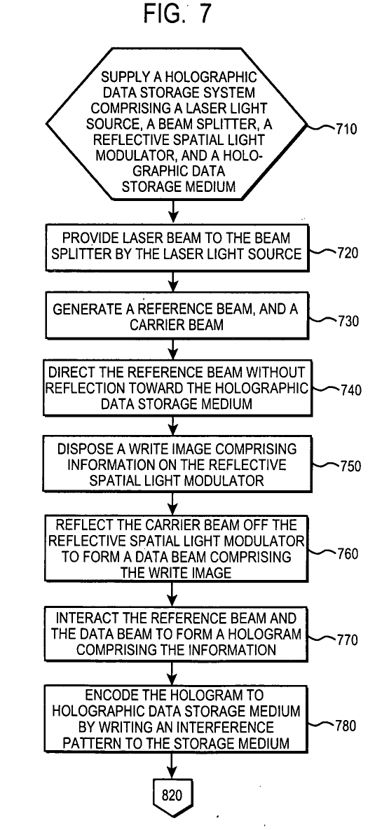

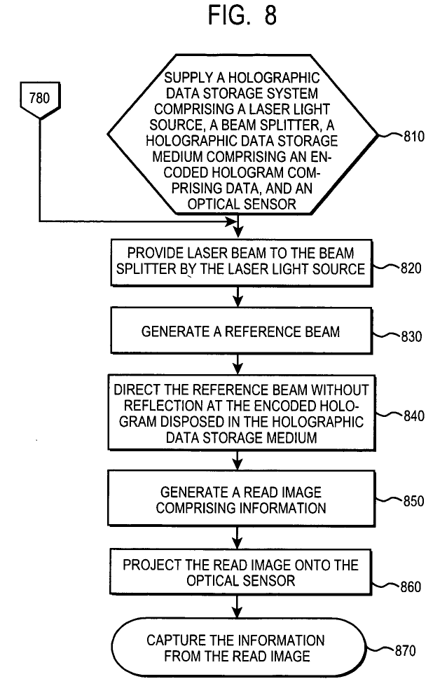

Applicants' invention further comprises a method to write information to, and/or read information from, a holographic information storage medium. FIG. 7 summarizes the steps of Applicants' method to write information to a holographic data storage medium. FIG. 8 summarizes the steps of Applicants' method to read information from a holographic data storage medium.

Referring now to FIG. 7, in step 710 Applicants' method supplies a holographic information storage system, such as for example Applicants' holographic information recording apparatus 200 (FIG. 2), comprising a laser light source, a beam splitter, a reflective spatial light modulator, and a holographic data storage medium.

In step 720, Applicants' method provides a laser beam to the beam splitter, such as beam splitter 110 (FIGS. 1, 2, 3, 4, 5), using the laser light source, such as laser source 105 (FIGS. 1, 2, 3, 4, 5). In step 730, Applicants' method generates a reference beam, such as reference beam 220 (FIGS. 2, 4), and a carrier beam, such as carrier beam 230 (FIG. 2).

In step 740, Applicants' method directs the reference beam of step 730 without reflection toward the holographic data storage medium, such as holographic data storage medium 195 (FIGS. 1, 2, 3, 4). By “without reflection,” Applicants mean that the reference beam of step 730 is not directed in a first direction at a mirror or similar reflective device, wherein that reflected reference beam is then directed in a different second direction toward the holographic data storage medium. Rather, the reference beam as generated by the beam splitter 110 is pointed directly at the holographic data storage medium.

In step 750, Applicants' method disposes a first image, i.e. a write image, comprising information on the reflective spatial light modulator, such as reflective spatial light modulator 210 (FIGS. 2, 3). In step 760, Applicants' method forms a data beam, such as data beam 240 (FIGS. 2, 3), comprising the write image, such as data image 205 (FIG. 3), by reflecting the carrier beam of step 730 off the reflective spatial light modulator. The data image 205 might be convolution encoded, to assist in the eventual reading of that data image 205.

In step 770, Applicants' method interacts the data beam of step 760 with the reference beam of step 740 to form a hologram, such as hologram 250 (FIG. 3) comprising the image of step 750. In step 780, Applicants' method encodes the hologram of step 770 in the holographic data storage medium. In certain embodiments, step 780 comprises forming an interference pattern, such as interference pattern 260 (FIG. 2) in the holographic data storage medium.

FIG. 8 summarizes the steps of Applicants' method to read information from a holographic data storage medium. Referring now to FIG. 8, in step 810 Applicants' method supplies a holographic information reading apparatus, such as Applicants' holographic information reading apparatus 500 (FIG. 5).

In step 820, Applicants' method optionally provides a laser beam to the beam splitter, such as beam splitter 110 (FIGS. 1, 2, 3, 4, 5), using the laser light source, such as laser source 105 (FIGS. 1, 2, 3, 4, 5). In step 830, Applicants' method generates a reference beam, such as reference beam 220 (FIGS. 2, 3, 5). In step 840, Applicants' method directs the reference beam of step 830 without reflection at an encoded hologram disposed in the holographic data storage medium. By “without reflection,” Applicants mean that the reference beam of step 830 is not directed in a first direction at a mirror or similar reflective device, wherein that reflected reference beam is then directed in a different second direction at the encoded hologram. Rather, the reference beam as generated by the beam splitter 110 is pointed directly at the encoded hologram.

In step 850, Applicants' method generates a read image comprising information. In embodiments wherein Applicants' method transitions from step 780 to step 820, the read image of step 850 comprises the same information as the write image of step 750. In step 860, Applicants' method projects the read image of step 850 onto the optical sensor, such as optical sensor 420 (FIGS. 4, 5). In step 870, Applicants' method captures the information comprising the read image, which is equivalent to data image 205 (FIG. 3). This step might include the trellis decoding of the read image to extract the actual data.

In certain embodiments, individual steps recited in FIG. 7 and/or FIG. 8 may be combined, eliminated, or reordered.

In certain embodiments, Applicants' invention includes instructions residing memory 663 (FIG. 6), where those instructions are executed by a processor, such as processor 664 (FIG. 6), to perform one or more of steps 720, 730, 740, 750, 760, 770, and/or 780, recited in FIG. 7, and/or one or more of steps 820, 830, 840, 850, 860, and/or 870, recited in FIG. 8.

In other embodiments, Applicants' invention includes instructions residing in any other computer program product, where those instructions are executed by a computer external to, or internal to, system 600, to perform one or more of steps 720, 730, 740, 750, 760, 770, and/or 780, recited in FIG. 7, and/or one or more of steps 820, 830, 840, 850, 860, and/or 870, recited in FIG. 8. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A holographic information recording apparatus, comprising:
a laser light source;
a beam splitter;
a reflective spatial light modulator;
wherein said beam splitter provides a reference beam and a carrier beam, wherein said reference beam is directed without reflection toward a holographic data storage medium;
wherein said carrier beam is reflected off said reflective spatial light modulator toward said holographic data storage medium.

2. The holographic information recording apparatus of claim 1, wherein said reflective spatial light modulator comprises a visual display device.

3. The holographic information recording apparatus of claim 2, wherein said visual display device comprises a liquid crystal on silicon visual display device.

4. The holographic information recording apparatus of claim 2, wherein said visual display device comprises a plurality of micro mirrors.

5. A holographic information reading apparatus, comprising:
a laser light source, wherein said laser light source provides a reference beam which is directed without reflection toward a holographic data storage medium comprising an encoded hologram comprising information;
an optical sensor to detect an image resulting from the interaction of said reference beam with said encoded hologram;
wherein said holographic information apparatus does not comprise a beam splitter.

6. The holographic information reading apparatus of claim 5, further comprising a beam splitter, wherein laser light source provides a laser beam to said splitter, and wherein said splitter provides said reference beam which is directed without reflection toward said holographic data storage medium comprising an encoded hologram comprising information.

7. A information storage system, comprising:
a holographic information storage system comprising a holographic data storage medium, a laser light source, a beam splitter to receive laser light from said laser light source, and a reflective spatial light modulator, wherein said beam splitter provides a reference beam and a carrier beam, wherein said reference beam is directed without reflection toward said holographic data storage medium, and wherein said carrier beam is reflected off said reflective spatial light modulator toward said holographic data storage medium;
one or more computing devices;
a storage server comprising a data controller interconnected with each of said one or more computing devices and with said holographic information storage system.

8. The information storage system of claim 7, wherein said reflective spatial light modulator comprises a visual display device.

9. The information storage system of claim 8, wherein said visual display device comprises a liquid crystal on silicon visual display device.

10. The information storage system of claim 8, wherein said visual display device comprises a plurality of micro mirrors.

11. The information storage system of claim 7, wherein said holographic data storage medium comprises an encoded hologram, further comprising an optical sensor to detect an image resulting from the interaction of said reference beam with said encoded hologram.

12. A method to write information to, and read information from, a holographic data storage medium, comprising the steps of:
supplying a holographic information storage system comprising a reflective spatial light modulator and a holographic data storage medium;
directing a reference beam without reflection toward said holographic data storage medium;
reflecting a carrier beam off said reflective spatial light modulator to generate a data beam comprising a first image of said information;
interacting said data beam with said reference beam to form a hologram comprising said first image within said holographic data storage medium.

13. The method of claim 12, wherein said supplying a holographic information storage system further comprises supplying a holographic information storage system comprising a reflective spatial light modulator comprising a liquid crystal on silicon display device.

14. The method of claim 12, wherein said supplying a holographic information storage system further comprises supplying a holographic information storage system comprising a plurality of micro mirrors.

15. The method of claim 12, further comprising the step of disposing said image comprising said information on said reflective spatial light modulator.

16. The method of claim 15, wherein said supplying a holographic information storage system further comprises supplying a holographic information storage system comprising a laser light source and a beam splitter, said method further comprising the steps of:
generating laser light using said laser light source;
providing said laser light to said beam splitter;
generating by said beam splitter said reference beam and said carrier beam.

17. The method of claim 12, further comprising the step of writing said hologram to said holographic data storage medium.

18. The method of claim 17, wherein said writing step further comprises the step of disposing an interference pattern comprising said hologram in said holographic data storage medium.

19. The method of claim 18, further comprising the steps of:
directing said reference beam without reflection on said interference pattern; and
forming a second image comprising said information.

20. The method of claim 19, wherein said supplying a holographic information storage system further comprises supplying a holographic information storage system comprising an optical sensor.

21. The method of claim 20, further comprising the step of projecting said second image onto said optical sensor.
